(19) United States
(12) Patent Application Publication
(10) Pub. No.: US 2005/0254764 A1
(43) Pub. Date: Nov. 17, 2005

(54) Double-clad optical fibers

(75) Inventor: Stephane Chatigny, St-Redempteur (CA)

Correspondence Address: GEORGE J. PRIMAK, 13480 HUNTINGTON, MONTREAL, QC, H8Z 1G2, CA

(73) Assignee: CorActive High-Tech Inc.

(21) Appl. No.: 11/074,220

(22) Filed: Mar. 8, 2005

(30) Foreign Application Priority Data
May 12, 2004 (CA) 2,466,970

(51) Int. Cl. G02B 6/02

(52) U.S. Cl. 385/123

(57) ABSTRACT

A double-clad optical fiber has an inner cladding with a pentagonal or heptagonal cross-section. The core of this fiber can be in the center or off-center. Moreover, the fiber may comprise stress field portions within the inner cladding which cause further distortions for deflecting pumped light to the core. In addition, the core may have a dual structure with an inner portion and an outer portion surrounding the inner portion. It is preferable that the inner cladding should have a lower index of refraction than the core and the outer cladding which surrounds the inner cladding should have a lower index of refraction than the inner cladding.

### FIELD OF THE INVENTION

The present invention generally relates to optical fiber devices and, more particularly to double-clad optical fibers adapted for use as optical amplifiers, optical fiber lasers or spontaneous emission sources.

### BACKGROUND OF THE INVENTION

Optical fiber lasers and amplifiers are today well known in the art. In such lasers and amplifiers, rare earth materials disposed in the core of the optical fiber laser or amplifier receive pump radiation and, responsive thereto, provide or amplify light for propagation in the core. For example, the well known erbium doped fiber amplifier (EDFA) receives pump radiation having a wavelength of 980 or 1480 nanometers (nm) and amplifies an optical signal propagating in the core at a wavelength in the 1550 nm region.

In such optical fiber lasers and amplifiers, the pump radiation can be introduced directly to the core, which can be difficult due to the small size of the core, or can be introduced to the cladding surrounding the core and absorbed by the core as the rays propagating in the cladding intersect the core. Lasers and amplifiers with the pump radiation introduced to the cladding are known as “cladding-pumped” optical devices, and facilitate the scale-up of lasers and amplifiers to higher power systems.

Absorption per unit length is a useful figure of merit for evaluating a cladding-pumped optical fiber laser or amplifier. It is typically desirable that the amplifier or laser have a high absorption per unit length, indicating that the pump radiation frequently intersects the core. Unfortunately, when the cladding has a circular outer circumference, a portion of the pump radiation can essentially propagate down the optical fiber while spiralling around the core without substantially intersecting the core. This leads to a low absorption per unit length of the optical fiber device, and hence detracts from the performance of the optical fiber laser or amplifier.

Various approaches are known in the art for enhancing the intersection of the pump radiation with the core and hence raising the absorption per unit length of the optical fiber amplifier or laser. For example, as disclosed in U.S. Pat. No. 4,815,079, issued Mar. 21, 1989 to Snitzer et al., the core can be offset from the center of the optical fiber so as to enhance the intersection of pump light with the core.

In another prior art optical fiber disclosed in U.S. Pat. No. 5,533,163, issued Jul. 2, 1996 to Muendel, the circumference of the inner cladding can be shaped as a polygon, such as a triangle, a square, a rectangle, a rhombus or a hexagon, which are all categorized as “convex polygons” having the property that if a plurality of said polygons are used to tile a plane, all of said polygons will fit into the tiling such that no spacing will be present between adjacent polygons, and further that all said polygons will be mirror images of one another about any common side. Thus, the above property limits the polygons of U.S. Pat. No. 5,533,163 to those having three, four or six-sided cross-section.

In another approach, the inner cladding has a D-shaped outer circumference that includes a flat section, as disclosed in U.S. Pat. No. 5,864,645, issued Jan. 26, 1999 to Zellmer et al.

Other approaches include providing a star-shaped outer circumference of the inner cladding, as disclosed in U.S. Pat. No. 5,873,923 dated Feb. 23, 1999, as well as U.S. Pat. No. 5,949,941 dated Sep. 7, 1999 and No. 5,966,491 dated Oct. 12, 1999, all issued to DiGiovanni. Also of interest is U.S. Pat. No. 6,411,762 issued Jun. 25, 2002 to Anthon et al., disclosing an optical fiber having a core, inner and outer claddings, and a series of perturbations or irregularities formed in the otherwise circular outer boundary of the inner cladding. The optical fiber is drawn from a preform having rods inserted into holes drilled into the preform for producing the irregularities.

In the foregoing prior art fibers, the non-circular shape of the outer circumference of the inner cladding is understood to cause ray distortion and mode mixing of light, thereby directing the light rays of the cladding radiation to the core, and avoiding trapping light in spiral paths that do not intersect the core.

Another approach disclosed in U.S. Pat. No. 6,157,763 issued Dec. 5, 2000 to Grubb et al. consists of providing a double-clad optical fiber having an inner cladding with a cross-sectional shape that is non-circular, but that maintains a good end-coupling profile. The cross-sectional shape of the inner cladding is such that two perpendicular distances across the shape, each of which passes through a geometric center of the core of the fiber, are equal for all angular positions. Thus, while mode mixing within the inner cladding is enhanced, the inner cladding does not suffer any oblong distortions of its shape, and is therefore more easily coupled to conventional fibers. The cross-sectional cladding shape may include various regions along its outer surface that do not conform to a circular geometry about a center of the core. These regions may include flat regions, or concave or convex regions, including an inner cladding that has an octagonal cross-sectional shape.

Also known in the art is U.S. Pat. No. 6,477,307 issued Nov. 5, 2002 to Tankala et al. In this patent, the outer circumference of the cladding includes a plurality of sections, where the plurality of sections includes at least one straight section and one inwardly curved section. An outer layer surrounds the cladding and has an index of refraction that is less than the second index of refraction. Tankala stated that the combination of the straight and inwardly curved sections in the outer circumference of the cladding enhances scattering of the pump radiation for more effective absorption of the pump radiation by the core. For example, the inwardly curved section can intercept the pump light reflected from the straight section in a substantially different direction, thus achieving a higher degree of randomization of the paths of the light rays of the pump light for increased interception of the light by the core of the optical fiber.

Moreover, there is U.S. Pat. No. 6,483,973 issued Nov. 19, 2002 to Mazzarese et al., disclosing an optical fiber wherein the cladding member has a circular exterior periphery and a predetermined refractive index n_{c}. The cladding member has an index modified region that directs light to the core member. The index modified region has a stress field portion with a predetermined refractive index ns. The difference between the refractive index of the cladding member and that of the stress field portion (n_{c}−nₛ) is within such a range that the stress field portion does not affect the polarization properties of the light travelling in the core member. This patent also discloses cladding members that are in the form of eight (8), nine (9), ten (10) and eleven (11) sided polygons which have been found to have high randomization efficiency and thus capable of sufficiently scattering light in the cladding member and yielding high clad-to-core energy transfer efficiency. It is further stated that such polygons are close to a circular shape and therefore are advantageous to splicing.

It should be noted, however, that many of the designs discussed above have disadvantages. For example, a fiber having an offset core can be difficult to interconnect with other optical components. Designs, such as the diamond and polygon shapes discussed above, that require the circumference of the cladding to predominately consist of flat areas, can be difficult to fabricate. The flat areas, which are typically first machined into the preform from which the optical fiber is drawn, tend to deform and change shape when the fiber is drawn at the most desirable temperatures. Accordingly, often the draw temperature is reduced to preserve the desired shape of the outer circumference of the cladding. A reduced draw temperature typically produces optical fibers having higher attenuation and lower mechanical strength. Also, the star shaped and flower shaped configurations disclosed in some of the prior art patent can be difficult to manufacture.

Therefore, it would still be desirable to provide a double-clad cladding-pumped optical fiber overcoming most of the above mentioned drawbacks and which is outside of the prior art configurations. More particularly, it would be desirable to provide an improved double-clad cladding-pumped optical fiber which would be easily manufactured and easily interconnectable with other optical components, while providing a good efficiency.

### SUMMARY OF THE INVENTION

An object of the present invention is to provide a double-clad optical fiber that satisfies the above mentioned needs.

Accordingly, the present invention provides a double-clad optical fiber having a core member surrounded by an inner cladding member receiving pump energy and transferring the pump energy to the core member, which is characterized in that the inner cladding member has a polygonal cross-section with five or seven sides. The double-clad optical fiber is also provided with an outer cladding surrounding the inner cladding member. Preferably, the outer cladding has a circularly shaped cross-section. This polygonal cross-section of the inner cladding provided with five or seven sides, namely a pentagonal or heptagonal cross-section, perturbs the propagation of light beams therein for providing a chaotic propagation of the beams which increases interception of the beams by the core member of the optical fiber, thereby improving the absorption of the pump energy by the core. Also, such double-clad optical fiber can easily be fused or spliced with another optical component such as an optical fiber having a circular cross-section.

It is indeed surprising and unexpected that despite the great variety of inner cladding cross-sections disclosed in the prior art referred to above, no one has suggested until now the possibility of using a pentagonal or heptagonal cross-section. The present applicant has found, however, by experimental analysis, that these shapes perform at least as well as the other polygonal shapes previously disclosed.

Thus, the essence of this invention is a double-clad optical fiber comprising:
(a) a core member;
(b) an inner cladding member surrounding the core member and having a polygonal cross-section with five or seven sides; and
(c) an outer cladding surrounding the inner cladding.

The core member constitutes the signal guide and normally it has a circular cross-section, although it may also have a non-circular cross-section such as for example, an elliptical cross-section. The core may be located in the center of the optical fiber or may be offset from the center. Preferably, it is silica-based and rare earth doped to provide an optical gain. The inner cladding is preferably made of pure silica or doped silica and advantageously has an index of refraction lower than that of the core. Finally, the outer cladding which surrounds the inner cladding is preferably made of a polymer material or of silicate glass and advantageously has an index of refraction lower than that of the inner cladding.

According to a further embodiment of the invention, one can provide stress inducing regions or stress field portions within the inner cladding which cause further ray distortions for deflecting pumped light to the core. These stress inducing regions may have various shapes, however the most common are called the panda type which incorporates borosilicate rods in the cladding and the bow tie type which is usually fabricated with a gas phase etching process. These stress inducing regions are normally made of a material having a different index of refraction than the core.

In a still further embodiment of the invention, the signal guiding core may have the shape of a ring, namely it has a dual core structure in which there is an inner core portion and an outer core portion surrounding the inner. Usually, one portion of the core is doped and the other undoped. Thus, the inner portion may be undoped while the outer portion doped with rare earth elements, or vice versa. When the outer portion is doped, it may also be made photosensitive for allowing a Brags grating to be inscribed therein.

### BRIEF DESCRIPTION OF THE DRAWINGS

Several exemplary embodiments of the invention are described below in the detailed description with reference to the accompanying drawings in which:

FIG. 1 is a cross-sectional view of a double-clad optical fiber having a pentagonal pump guide, according to one embodiment of the present invention;

FIG. 2 is a cross-sectional view of a double-clad optical fiber having a heptagonal pump guide, according to another embodiment of the present invention;

FIG. 3 is a schematic representation illustrating a radial refractive-index profile of a double-clad optical fiber for the embodiments shown in FIGS. 1 and 2;

FIG. 4A is a cross-sectional view of a double-clad optical fiber provided with an elliptic core within a pentagonal pump guide;

FIG. 4B is a cross-sectional view of a double-clad optical fiber provided with an elliptic core within a heptagonal pump guide;

FIG. 5A is a cross-sectional view of a double-clad optical fiber wherein the core is off-centered within a pentagonal pump guide;

FIG. 5B is a cross-sectional view of a double-clad optical fiber wherein the core is off-centered, within a heptagonal pump guide;

FIG. 6A is a cross-sectional view of a double-clad optical fiber provided with stress rods within a pentagonal pump guide;

FIG. 6B is a cross-sectional view of a double-clad optical fiber provided with rods within a heptagonal pump guide;

FIG. 6C is a cross-sectional view of a double-clad optical fiber provided with stress bow tie type elements within a pentagonal pump guide;

FIG. 6D is a cross-sectional view of a double-clad optical fiber provided with stress bow tie type elements within a heptagonal pump guide;

FIG. 7A is a cross-sectional view of a double-clad optical fiber provided with a ring core in which the outer portion of the core is doped and the inner portion is undoped, within a pentagonal pump guide;

FIG. 7B is a cross-sectional view of a double-clad optical fiber provided with a ring core in which the outer portion of the core is doped and the inner portion is undoped, within a heptagonal pump guide;

FIG. 8A is a cross-sectional view of a double-clad optical fiber provided with a ring core in which the inner portion of the core is doped and the outer portion is undoped, within a pentagonal pump guide;

FIG. 8B is a cross-sectional view of a double-clad optical fiber provided with a ring core, in which the inner portion of the core is doped and the outer portion is undoped, within a heptagonal pump guide; and

FIG. 9 is a graph showing the slope efficiency of two double clad Er/Yb amplifiers, one provided with the known hexagonal pump guide and the other with the heptagonal pump guide of the present invention.

### DETAILED DESCRIPTION OF THE INVENTION

In the following description, the same features shown in the drawings have been given the same reference numerals.

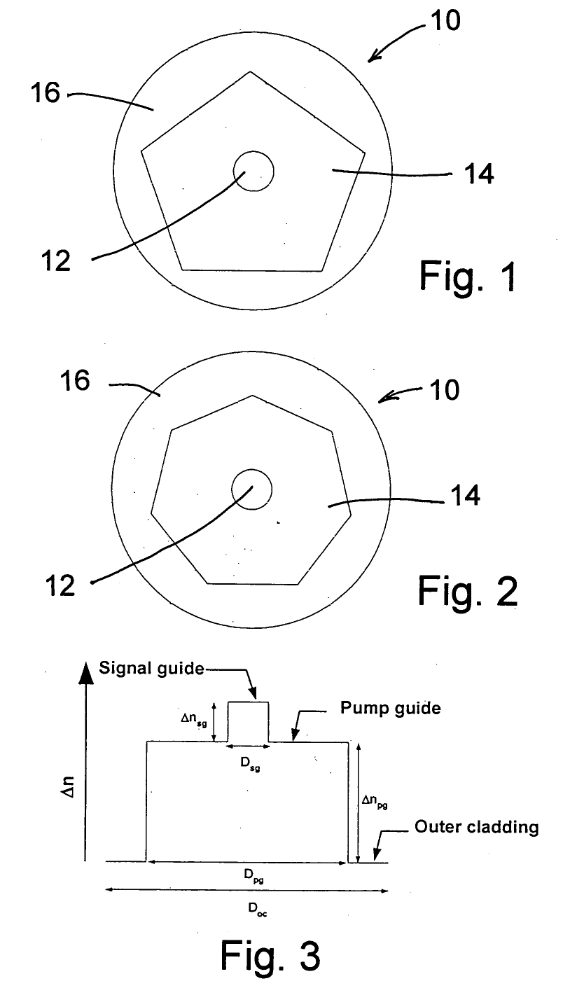

Referring to FIG. 1, there is shown an embodiment of the double-clad optical fiber 10 of the present invention. The optical fiber 10 is provided with a core 12 which in this case has a circular cross-section. In this embodiment, the core 12 extends centrally in the optical fiber 10. Preferably, the core is silica-based co-doped with elements increasing or decreasing the index of refraction of the core, and with rare earth elements providing an optical gain. However, it should be understood that other type of glass could also be used, according to a particular application. For example, fluoride or chalcogenide glasses that can be used to access transition forbidden in silica glasses due their lower phonon energy. The core 12 is surrounded by an inner cladding member 14 defining a pump guide for receiving pump energy and transferring the pump energy to the core 12. The inner-cladding 14 is preferably a pure silica cladding having an index of refraction lower than the index of refraction of the core 12. The inner-cladding 14 has a pentagonal cross-section. This cross-section perturbs the propagation of light beams in the inner cladding 14 for providing a chaotic propagation of the beams, which increases interception of the beams by the core 12, thereby improving the absorption of pump energy by the core 12. The double-clad optical fiber 10 is also provided with an outer cladding 16 surrounding the inner cladding 14. The outer cladding 16 is preferably made of polymer materials or a silicate glass with a refractive index lower than that of the inner cladding 14. Preferably, the outer cladding 16 has a circular cross-section. The core 12 and the inner cladding 14 thus define a monomode or multimode waveguide in the rare earth materials amplification band while the inner cladding 14 and the outer cladding 16 define a multimode waveguide allowing to couple a pump longitudinally propagating therein.

FIG. 2 shows another embodiment of the double-clad optical fiber 10 of the present invention, wherein the cross-section of the inner cladding 14 is heptagonal. Apart from being heptagonal, it has essentially the same characteristics as those described above for the pentagonal inner cladding and its core 12 and outer cladding 16 are arranged in the same manner as shown in FIG. 1.

FIG. 3 illustrates the preferred refractive index profile for the fibers of FIGS. 1 and 2. It shows that preferably the index of refraction of the signal guide, namely the core; is the highest, while that of the pump guide or the inner cladding is somewhat lower, and the index of refraction of the outer cladding is significantly lower than that of the inner cladding. The relative diameters of the core, the inner cladding and the outer cladding are also illustrated in this figure.

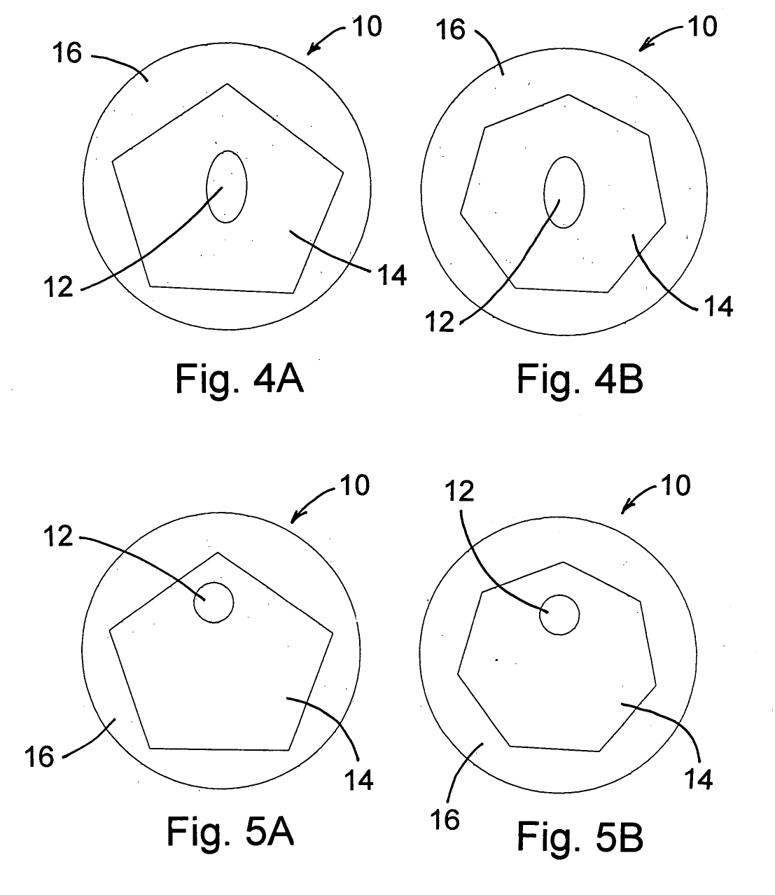

FIGS. 4A and 4B show two other embodiments of the double-clad optical fiber 10 of the present invention wherein the core 12 is elliptically shaped, while the inner cladding 14 and the outer cladding 16 remain as shown in FIGS. 1 and 2. These embodiments may advantageously be used when a polarization maintaining fiber is required.

FIGS. 5A and 5B show double-clad optical fibers 10 wherein the core 12 is offset from the center of the inner cladding 14 of the optical fiber 10.

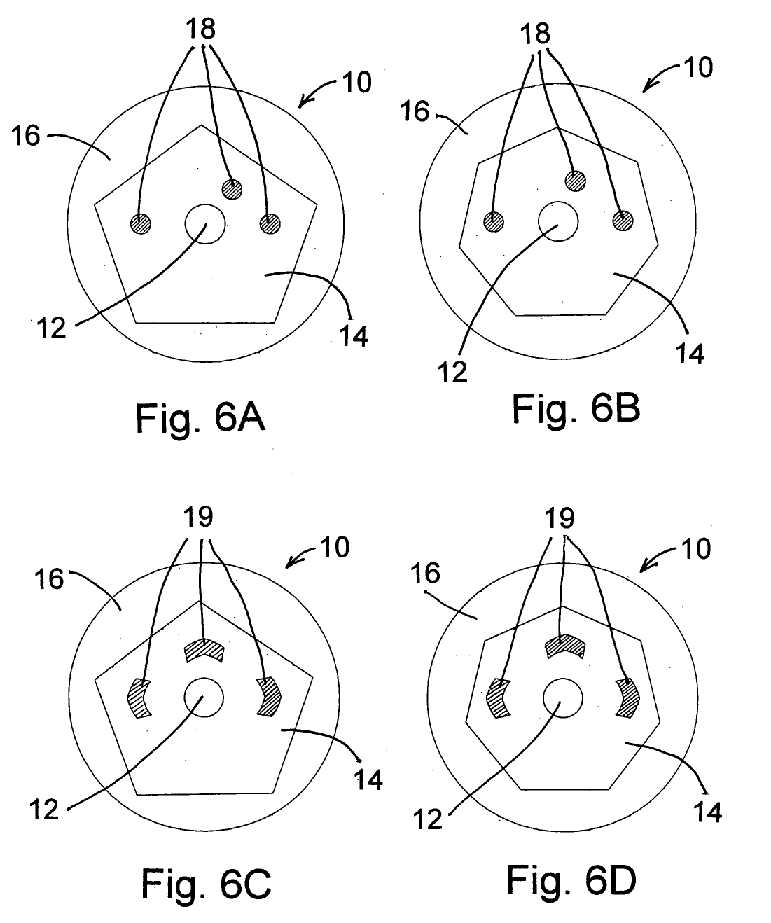

FIGS. 6A to 6D show double-clad optical fibers 10 provided with stress field portions 18 extending in the inner cladding 14 in order to perturb further the propagation of the pump signal in the pump guide. In FIGS. 6A and 6B, the stress field portions 18 are stress rods longitudinally extending in the inner cladding 14 while in FIGS. 6C and 6D, the stress field portions 19 are bow tie type. These stress field portions, in an appropriate geometry, may advantageously provide a polarization maintaining fiber.

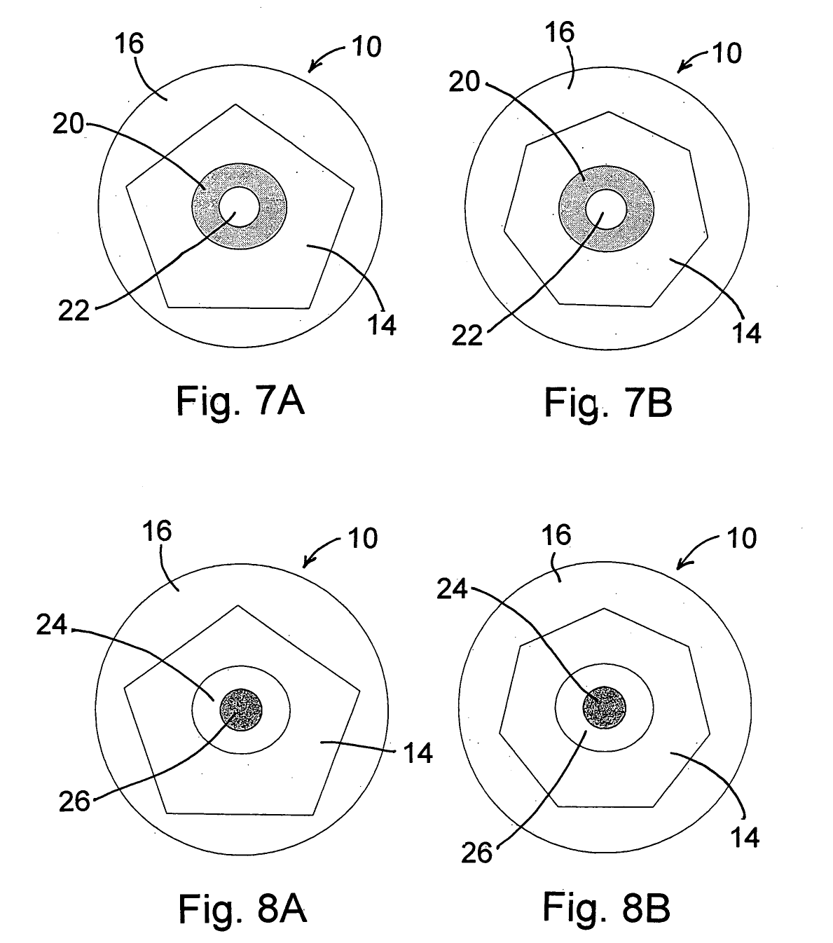

Referring now to FIGS. 7A, 7B, 8A and 8B, there are shown four other preferred embodiments of the present invention wherein the core is a ring core, while the inner cladding 14 and the outer cladding 16 are essentially the same as in FIGS. 1 and 2. In FIGS. 7A and 7B, the core comprises an outer portion 20 being rare earth doped and an inner portion 22 being undoped. In FIGS. 8A and 8B, the core comprises an outer portion 24 being undoped and an inner portion 26 being rare earth doped. In these two latter preferred embodiments, the outer portion 24 may have the same or a different index of refraction as the doped inner portion 26. Moreover, this outer portion 24 may be photosensitive for allowing a Bragg grating to be inscribed therein. Preferably, this photosensitive outer portion comprises a high content of GeO₂ or a B₂O₃—GeO₂ doping.

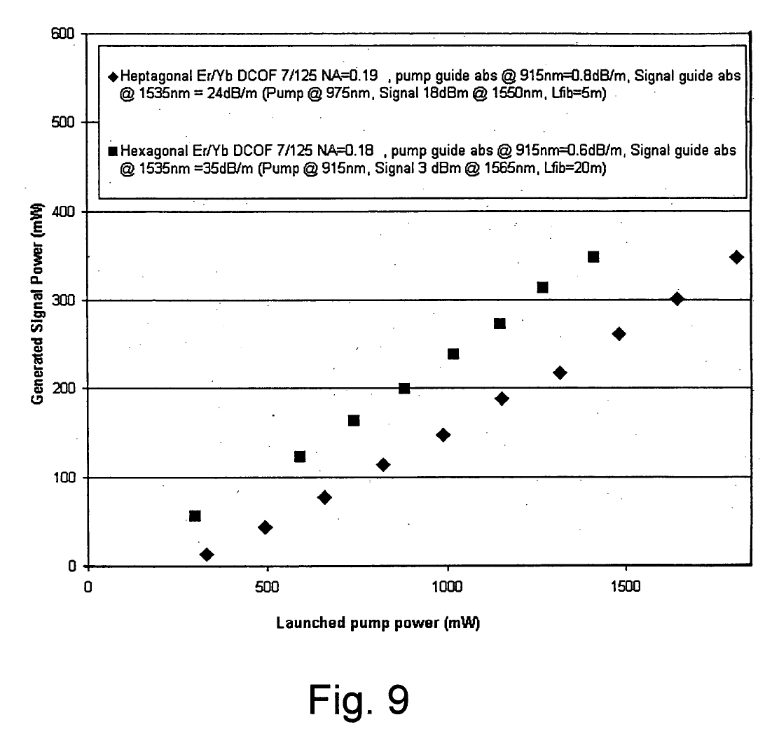

FIG. 9 provides a graph showing comparative example of slope efficiency between two similar double clad Er/Yb amplifiers, one of which has a hexagonal inner cladding cross-section which is known in the prior art, such as U.S. Pat. No. 5,533,163, and the other has a heptagonal inner cladding cross-section according to one embodiment of the present invention. In this graph, the generated signal power is plotted as a function of the launched pump power.

The amplifier with the hexagonal pump guide was an Er/Yb DCOF 7/125 fiber having a numerical aperture NA=0.18, the pump guide abs@915 nm=0.6 dB/m and the signal guide abs@1535 nm=35 dB/m.

The amplifier with the heptagonal pump guide was an Er/Yb DCOF 7/125 fiber having NA=0.19, the pump guide abs@915=0.8 dB/m and the signal guide abs@1535 nm=24 dB/m.

In both cases, the slope efficiency exceeded the threshold level of 20% which is considered to be satisfactory for such amplifiers and is clearly comparable between the two double clad fibers.

Thus, the optical structures described above provide as good or improved efficiency in comparison with optical structures proposed in the prior art while also providing an easy manufacturing. Moreover, the optical structures of the present invention offer an interesting compromise regarding the ease of fusion or splicing with other optical components, such as an optical fiber having a circular cross section.

Although several preferred embodiments of the present invention have been described in detail herein and illustrated in the accompanying drawings, it is to be understood that the invention is not limited to these precise embodiments and that various changes and modifications may be effected therein without departing from the scope of the present invention as defined in the appended claims.

1. A double-clad optical fiber comprising:
(a) a core member;
(b) an inner cladding member surrounding the core member and having a polygonal cross-section with five or seven sides; and
(c) an outer cladding surrounding the inner cladding.

2. A double-clad optical fiber according to claim 1, in which the inner cladding member has a pentagonal cross-section.

3. A double-clad optical fiber according to claim 1, in which the inner cladding member has a heptagonal cross-section.

4. A double-clad optical fiber according to claim 1, in which the core member has a circular cross-section.

5. A double-clad optical fiber according to claim 1, in which the core member has an elliptical cross-section.

6. A double-clad optical fiber according to claim 1, in which the core member is located in the center of the fiber.

7. A double-clad optical fiber according to claim 1, in which the core member is located off-center in the fiber.

8. A double-clad optical fiber according to claim 1, further comprising stress field portions within the inner cladding.

9. A double-clad optical fiber according to claim 8, in which the stress field portions consist of a plurality of stress rods.

10. A double-clad optical fiber according to claim 8, in which the stress field portions consist of a plurality of bow tie type elements.

11. A double-clad optical fiber according to claim 1, in which the core member has a dual core structure with an inner core portion and an outer core portion surrounding the inner core portion.

12. A double-clad optical fiber according to claim 11, in which the inner core portion is undoped and the outer core portion is doped with rare earth elements.

13. A double-clad optical fiber according to claim 11, in which the outer core portion is undoped and the inner core portion is doped with rare earth elements.

14. A double-clad optical fiber according to claim 12, in which the outer core portion is photosensitive and a Bragg grating is inscribed thereon.

15. A double-clad optical fiber according to claim 1, in which the inner cladding member is made of pure silica or doped silica and has a lower index of refraction than the core member.

16. A double-clad optical fiber according to claim 15, in which the outer cladding is made of a polymer material and has a lower index of refraction than the inner cladding member.

17. A double-clad optical fiber comprising:
(a) a core member made of silica doped with at least one rare earth element providing an optical gain;
(b) an inner cladding member surrounding the core member and having an index of refraction lower than that of the core member, said inner cladding member also having a pentagonal or heptagonal cross-section; and
(c) an outer cladding surrounding the inner cladding member, said outer cladding being made of a polymer material and having an index of refraction lower than that of the inner cladding member.

18. A double-clad optical fiber according to claim 17, in which the core member is located at the center or off-center of the fiber.

19. A double-clad optical fiber according to claim 17, in which the core member has a dual structure with an inner core portion and an outer core portion surrounding the inner core portion.

20. A double-clad optical fiber according to claim 17, further comprising stress field portions within the inner cladding.
